(19) United States
(12) Patent Application Publication
(10) Pub. No.: US 2012/0211333 A1
(43) Pub. Date: Aug. 23, 2012

(54) Leak-Resistant Subdeck

(76) Inventor: David W. Lutz, Carlisle, PA (US)

(21) Appl. No.: 13/329,515

(22) Filed: Dec. 19, 2011

Related U.S. Application Data
(60) Provisional application No. 61/425,928, filed on Dec. 22, 2010.

(51) Int. Cl. B65G 25/04

(52) U.S. Cl. 198/750.3

(57) ABSTRACT

A subdeck and slat assembly for a reciprocating slat conveyor includes a plurality of supports having protrusions extending outwardly therefrom. The protrusions have an exterior profile comprising an upwardly facing portion and a downwardly facing portion. The supports further include an upper channel. A bearing sleeve has an inner profile complimentary to at least a portion of the exterior profile of the support. The bearing sleeve further includes an angled tip configured to engage the channel of the protrusion. A slat has an inner profile complimentary to at least a portion of the outer profile of the bearing sleeve and is configured to slide along the bearing sleeve.

### CROSS REFERENCE TO RELATED APPLICATION

This application claims priority to U.S. Patent Application No. 61/425,928, filed on Dec. 22, 2010, which application is herein incorporated by reference in its entirety.

### BACKGROUND OF THE INVENTION

1. Field of the Invention

This invention relates generally to reciprocating slat conveyors for loading or unloading cargo from a receptacle and, more particularly, to reciprocating slat conveyors having a leak-resistant configuration.

2. Technical Considerations

Conventional reciprocating slat conveyors are used for loading and unloading receptacles with bulk cargo, such as garbage, paper, fertilizer, wood chips, sawdust, and the like. The receptacles can be mobile, such as a trailer, or fixed in place. The conveyor floor includes reciprocating slats located on the floor of the receptacle. The slats are joined to cross members attached to a drive assembly, such as a hydraulic or pneumatic drive assembly. For example, a hydraulic drive having hydraulic cylinders can be positioned under the middle of the conveyor floor or at the front of the trailer to move the slats. The cylinders can be actuated to move all of the slats simultaneously to load or unload the receptacle or to move sets of slats sequentially to retract the slats back to a starting position.

For many applications, such as the transportation of paper products, it is desirable that the cargo does not drop through the floor of the trailer onto the road. For this purpose, leak-resistant conveyor systems have been developed. For example, some conveyor systems incorporate a metal pan or tub under the conveyor to catch any material passing through the slats. Other conveyor systems incorporate complex sealing devices that can complicate the construction of the conveyor system and increase the cost.

Therefore, it would be advantageous to provide a leak-resistant slat conveyor system that reduces or eliminates at least some of these problems and which is different than currently available.

### SUMMARY OF THE INVENTION

A subdeck and slat assembly for a reciprocating slat conveyor comprises a plurality of supports having protrusions or “hips” extending outwardly therefrom. Each protrusion has an outer profile comprising an upwardly facing portion and a downwardly facing portion. Each support further includes at least one upper channel. A bearing sleeve has an inner profile complimentary to at least a portion of the outer profile of the support. The bearing sleeve includes an angled tip configured to engage or extend into the upper channel of the support. A slat has an inner profile complimentary to at least a portion of the outer profile of the bearing sleeve and is configured to slide along the bearing sleeve.

Another subdeck and slat assembly comprises a plurality of supports. Each support has a substantially U-shape defining a channel and also has projections facing into the channel. Each projection has an outer profile with a downwardly facing portion or surface. A plastic slat has a projection having an upwardly facing surface substantially complimentary to the downwardly facing surface of the profile. Each slat includes a groove on one side and a channel on the other side. An end of an elastomeric bearing element has one end configured to engage the slat groove and another end that extends into the channel on the adjacent slat. The channel has an upwardly facing surface and the outer end of the bearing element has an angled tip with a downwardly facing surface configured to engage the upwardly facing surface of the channel.

### BRIEF DESCRIPTION OF THE DRAWINGS

The invention will be described with reference to the following drawing figures wherein like reference numbers refer to like parts throughout.

FIG. 1 is an end view of a conveyor incorporating features of the invention;

FIG. 2 is a perspective view of a portion of the conveyor of FIG. 1;

FIG. 3 is an end view of another conveyor incorporating features of the invention;

FIG. 4 is a perspective view of a portion of the conveyor of FIG. 3; and

FIG. 5 is an end view of a further conveyor incorporating features of the invention.

### DESCRIPTION OF THE PREFERRED EMBODIMENTS

As used herein, spatial or directional terms, such as “left”, “right”, “inner”, “outer”, “above”, “below”, “top”, “bottom”, and the like, relate to the invention as it is shown in the drawing figures. However, it is to be understood that the invention can assume various alternative orientations and, accordingly, such terms are not to be considered as limiting. Further, as used herein, all numbers expressing dimensions, physical characteristics, and the like, used in the specification and claims are to be understood as being modified in all instances by the term “about”. Accordingly, unless indicated to the contrary, the numerical values set forth in the following specification and claims may vary depending upon the desired properties sought to be obtained by the present invention. At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. As used herein, the terms “polymer” or “polymeric” include oligomers, homopolymers, copolymers, and terpolymers, e.g., polymers formed from two or more types of monomers or polymers. Additionally, all documents, such as, but not limited to, issued patents and patent applications, referred to herein are to be considered to be “incorporated by reference” in their entirety.

A conveyor having a subdeck and slat configuration suitable for use with a reciprocating slat conveyor will now be described. The conveyor can be used with any conventional drive device, such as, but not limited to, an undermount or a front mount hydraulic or pneumatic piston drive assembly. In an undermount drive assembly, the pistons are located under the floor of the trailer and connectors or “shoes” attached to cross beams extend upwardly through a hole in the floor of the trailer to connect to the bottom of the slats. In a front mount drive assembly, the pistons are located at the front of the trailer and are attached to the top of the slats. Such conventional drive devices will be well understood by one of ordinary skill in the art and will not be discussed in detail herein.

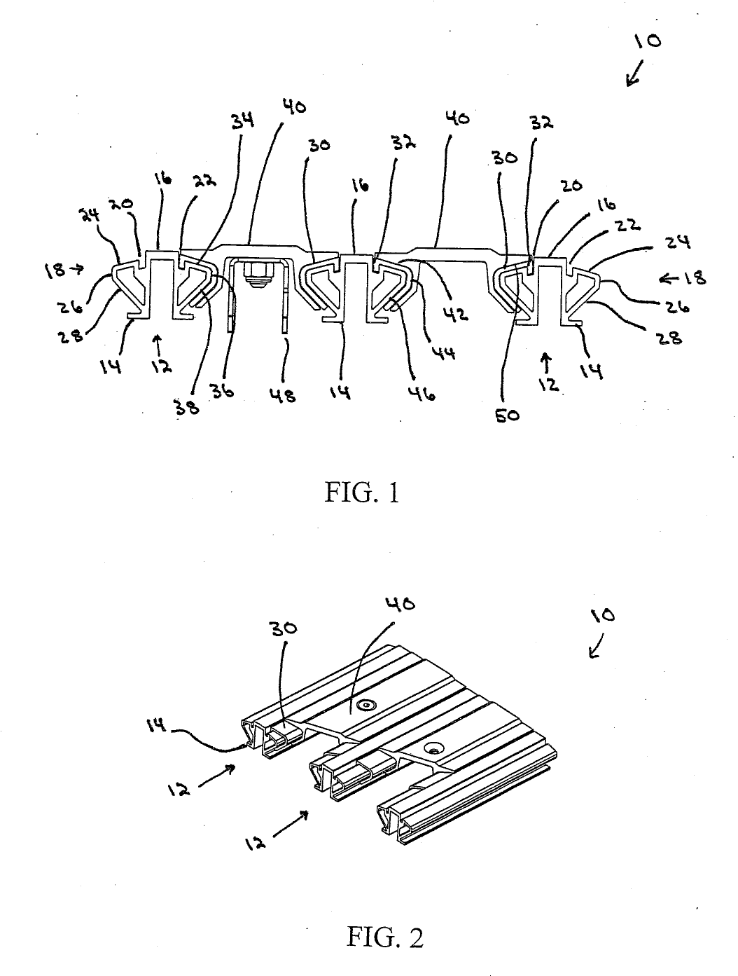

FIGS. 1 and 2 show an end view and perspective view, respectively, of a conveyor having a subdeck and slat assembly 10 of the invention. The subdeck includes supports 12 having an exterior profile. In the illustrated embodiment, the supports 12 include a base 14, a flat top 16, and side structures or protrusions 18 having an exterior profile. In the illustrated embodiment, the support 12 includes a pair of grooves or channels 20, 22 positioned on either side of the flat top 16 and running along the length of the support 12. The protrusions 18 include an upwardly facing portion 24, a substantially vertical portion 26, and a downwardly facing portion 28. The support 12 can be made of any suitable material, such as metal, for example, aluminum.

Bearing sleeves 30 of a low friction material, such as plastic material, are removably connected to the support 12. The bearing sleeves 30 include an angled tip 32 configured to engage or slide in one of the channels 20, 22. The bearing sleeves 30 include an inner profile having a downwardly facing portion 34, a substantially vertical portion 36, and an upwardly facing portion 38 that conform or are complimentary to at least a portion of the exterior profile of the protrusion 18. The bearing sleeves 30 can be connected to the support 12 by slipping one end (forward end) of the bearing sleeve 30 onto the end of one of the protrusions 18 and then sliding the bearing sleeve 30 forward so that the inner profile of the bearing sleeve 30 mates with at least a portion of the other profile of the protrusion 18. The bearing sleeves 30 can be retained on the support 12 by an end cap or similar fastening device at the rear end and/or the front end of the support 12. Alternatively, the front end of the bearing sleeve 30 can abut against the front wall of the trailer. Thus, the bearing sleeves 30 extend along substantially the entire length of the support 12.

Slats 40 are movable along the supports 12. The slats 40 have an outer profile that is complimentary to at least a portion of the outer profile of the bearing sleeve 30 to help mate the slat 40 to the bearing sleeve 30 (and, thus, the support 12). In the illustrated embodiment, each side of the slat 40 has a downwardly facing portion 42, a substantially vertical portion 44, and an upwardly facing portion 46 that mate with or substantially conform to the exterior profile of the bearing sleeve 30. The slat 40 is shown connected to a conventional undermount connector or “shoe” which is, in-turn, connected to the drive assembly. As will be appreciated, when cargo is loaded onto the conveyor (i.e., onto the slats 40), the weight of the material on top of the slats 40 presses the slats 40 downwardly such that the downwardly facing portion 42 of the slat 40 is pressed against an upper portion 50 of the bearing sleeve 30 so that no gap is present between the slat 40 and the upper portion 50 of the bearing sleeve 30. The bearing sleeve 30 is, in turn, pressed downwardly against the upwardly facing portion 24 of the protrusion 18. Thus, bulk material cannot pass between the slat 40 and the bearing sleeve 30 or between the bearing sleeve 30 and the support 12.

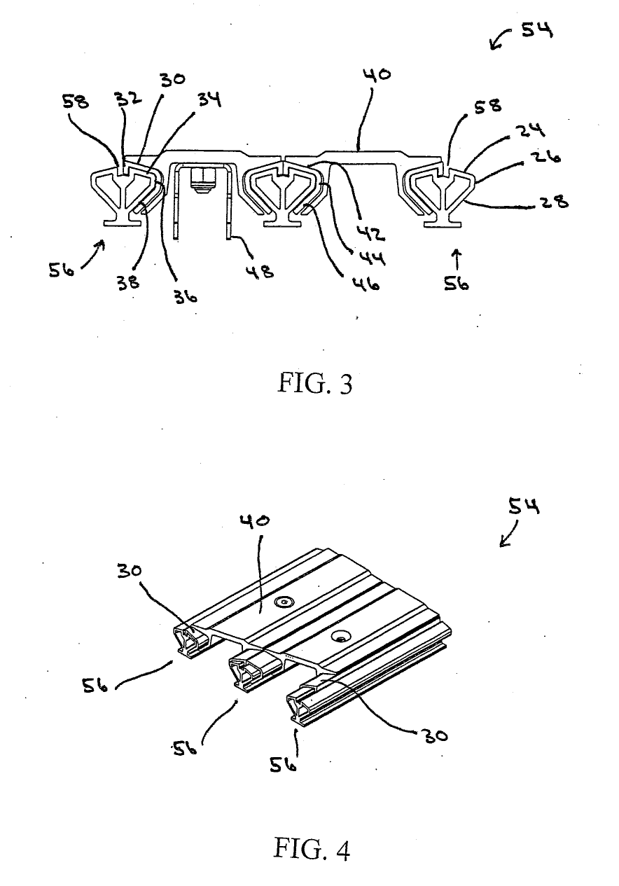

Another conveyor having a subdeck and slat assembly 54 of the invention is shown in FIGS. 3 and 4. This embodiment is similar to the embodiment described above but the support 56 does not include a flat top as described above. In this embodiment, a support 56 includes a single channel 58 on top of the support 56 into which the angled tips 32 of the bearing sleeves 30 are engaged, with one tip 32 adjacent the tip 32 of the adjacent bearing sleeve 30.

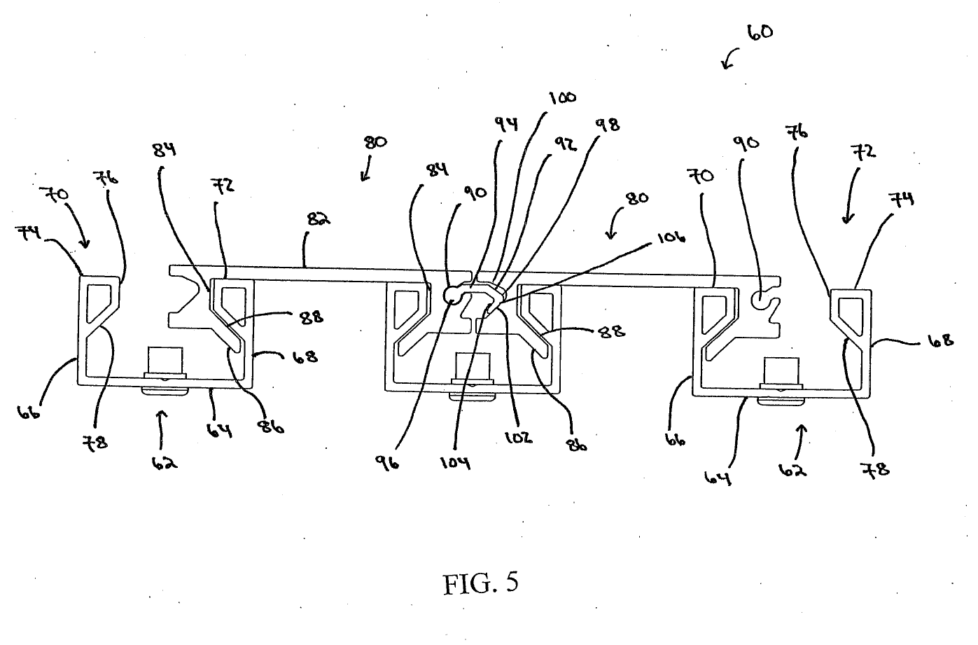

A further conveyor subdeck and slat assembly 60 is shown in FIG. 5. In this embodiment, the supports 62 are substantially “U-shaped” and have a base 64 and sidewalls 66, 68 defining an inner channel. The support 62 includes a pair of opposed, inwardly facing profiles 70, 72. The profiles 70, 72 have a flat top 74, a substantially vertical portion 76, and an angled portion having a substantially downwardly facing surface 78. The supports 62 can be made of any suitable material, such as metal, e.g., aluminum.

The slats 80 of this embodiment have a flat top 82 with sides having an inner profile that is complimentary to at least a portion of the outer profiles of the profiles 70, 72. In the illustrated embodiment, the sides of the slats include a substantially vertical portion 84 and an extension or projection 86 extending angularly downwardly from the slat 80. The projection 86 has an upwardly facing surface 88 that extends along at least a portion of the downwardly facing surface 78 of the profile 70. One side of the slat 80 has a groove 90 and the other side of the slat 80 has a channel 92. The slats 80 are positioned such that the groove 90 of one slat 80 faces the channel 92 of the adjacent slat 80. A flexible member 94, such as a rubber or plastic strip, has one end (inner end) 96 configured to engage and be retained in the groove 90 of one slat 80 and another end (outer end) 98 configured to extend into the channel 92 of the adjacent slat 80. In the illustrated embodiment, the channel 92 includes a downwardly facing surface 100 and an upwardly facing surface 102. The outer end 98 of the flexible member 94 has an angled portion 104 with a downwardly facing surface 106 configured to engage or slide along the upwardly facing surface 102 of the channel 92. The flexible member 94 helps reduce or prevent debris falling through the gap between adjacent slats 80. However, even if debris should fall through the gap, it would fall into the channel formed by the U-shaped support 62 and, thus, would not fall out of the bottom of the trailer. Also, in this embodiment, the slats 80 can themselves be made of a low friction material, such as plastic, such that a separate bearing sleeve is not required in this embodiment. The slats 80 can be connected to a drive device in any conventional manner, such as by being connected to shoes of a drive assembly.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the full breadth of the appended claims and any and all equivalents thereof.

The invention claimed is:

1. A subdeck and slat assembly for a reciprocating slat conveyor, comprising:
a plurality of supports having protrusions extended outwardly therefrom, each protrusion having an exterior profile comprising an upwardly facing portion and a downwardly facing portion, wherein each support further includes at least one upper channel;
a bearing sleeve having an inner profile complimentary to at least a portion of the exterior profile of the support, the bearing sleeve further including an angled tip configured to engage the channel of the protrusion; and
a slat having an inner profile complimentary to at least a portion of the outer profile of the bearing sleeve and configured to slide along the bearing sleeve.

2. The assembly of claim 1, wherein the support includes a flat top with a channel formed along each side of the flat top.

3. A subdeck and slat assembly, comprising:
a plurality of supports, each support having a substantially U-shape defining a channel and each support having inwardly facing projections, with each projection having a downwardly facing surface;
a plastic slat having a projection with an upwardly facing surface substantially complimentary to the downwardly facing surface of the profile, wherein each slat includes a groove on one side and a channel on the other side, wherein the channel includes a downwardly facing surface and an upwardly facing surface; and
an elastomeric bearing element having one end configured to engage the groove and another end configured to extend into the channel of the adjacent slat, wherein the bearing element includes an angled tip having a downwardly facing surface configured to engage the upwardly facing surface of the channel.
